(19) United States
(12) Patent Application Publication
(10) Pub. No.: US 2025/0251907 A1
(43) Pub. Date: Aug. 7, 2025

(54) PROCESSING METHOD AND RELATED PROCESSING DEVICE FOR NUMERICAL DATA

(71) Applicant: Realtek Semiconductor Corp., HsinChu (TW)

(72) Inventor: Chih-Hao Liu, HsinChu (TW)

(73) Assignee: Realtek Semiconductor Corp., HsinChu (TW)

(21) Appl. No.: 18/795,195

(22) Filed: Aug. 6, 2024

(30) Foreign Application Priority Data
Feb. 2, 2024 (TW) 113104082

(51) Int. Cl. G06F 7/08

(52) U.S. Cl. CPC G06F 7/08

(57) ABSTRACT

A numerical data processing method includes transforming a plurality of original numerical values of data into a plurality of number sequences; and determining a maximal value, a minimal value and at least a survival value of the plurality of number sequences according to a sorting result of the plurality of number sequences; wherein the plurality of number sequences are one-hot encoding.

### BACKGROUND OF THE INVENTION

### 1. Field of the Invention

The present invention relates to a processing method and a related processing device for numerical data, and more particularly, to a processing method and a related processing device for numerical data, capable of analyzing and classifying data.

### 2. Description of the Prior Art

For applications of data analysis of conventional deep learning, e.g., the neural network or the survival path detector, the data distribution and data sorting are necessary to obtain the characteristic values of the data. Alternatively, the data distribution and the data sorting are necessary for classifier to determine specific value ranges, i.e., the survival value searching.

When implementing the above methods with the conventional hardware technique, more comparators and counters are needed to determine the data distribution, and the sorter network with higher complexity is required for sorting. However, when the number of input is increased, more D-type Flip-Flop pipelines are needed, which increases the circuitry area of the hardware.

Therefore, improvements are necessary to the conventional techniques.

### SUMMARY OF THE INVENTION

In light of this, the present invention relates to a processing method and a related processing device for numerical data to analyze and classify the numerical data with shorter critical paths in circuitry.

An embodiment of the present invention discloses a numerical data processing method, comprises transforming a plurality of original numerical values of data into a plurality of number sequences; and determining a maximal value, a minimal value and at least a survival value of the plurality of number sequences according to a sorting result of the plurality of number sequences; wherein the plurality of number sequences are one-hot encoding.

Another embodiment of the present invention discloses a numerical data processing device, comprises a shifter circuit, for receiving a plurality of original numerical values of data and transforming the plurality of original numerical values of the data into a plurality of number sequences; a sorting circuit, for sorting the plurality of number sequences and determining a maximal value, a minimal value of the plurality of number sequences according to a sorting result of the plurality of number sequences; and a data distribution circuit, for determining at least a survival value according to the plurality of number sequences; wherein the plurality of number sequences are one-hot encoding.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a numerical data processing method according to an embodiment of the present invention.

FIG. 2 is a schematic diagram of a numerical data processing device according to an embodiment of the present invention.

FIG. 3 is a schematic diagram of a sorting circuit according to an embodiment of the present invention.

FIG. 4 is a schematic diagram of a data distribution circuit according to an embodiment of the present invention.

### DETAILED DESCRIPTION

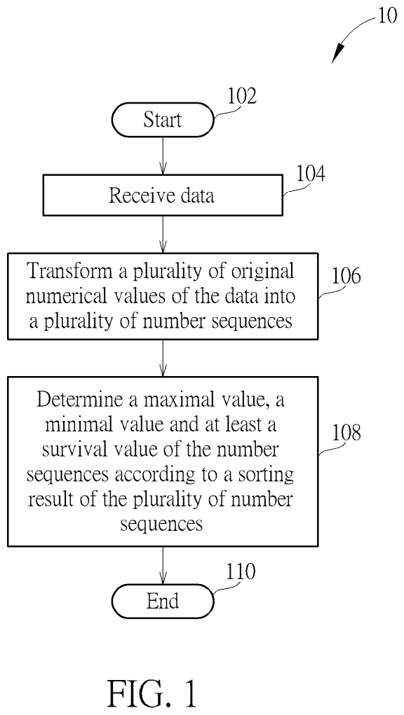

Please refer to FIG. 1, which is a schematic diagram of a numerical data processing method 10 according to an embodiment of the present invention. The numerical data processing method 10 may be utilized for a multi-input multi-output (MIMO) system of a wireless network. After the MIMO antenna receives the signal, distances between signal points of a constellation diagram are determined for sorting and analysis of distribution of distance values, and characteristic values of the numerical data are determined accordingly. The numerical data processing method 10 includes the following steps:
Step 102: Start;
Step 104: Receive data;
Step 106: Transform a plurality of original numerical values of the data into a plurality of number sequences;
Step 108: Determine a maximal value, a minimal value and at least a survival value of the number sequences according to a sorting result of the plurality of number sequences;
Step 110: End.

The numerical data processing method 10 according to an embodiment of the present invention receives the numerical data in step 104. In step 106, the original numerical values of data are transformed into the plurality of number sequences, wherein the number sequences are one-hot encoding, i.e. each of the number sequences includes at most a bit 1 in the range.

In an embodiment, decimal 3-bit values are transformed into 8-bit values in step 106, e.g. a 3-bit value 6 (3′d6) is transformed into an 8-bit numerical sequence 01000000. And then, the maximal value, the minimal value and the at least a survival value of the number sequences are determined according to the plurality of number sequences in step 108.

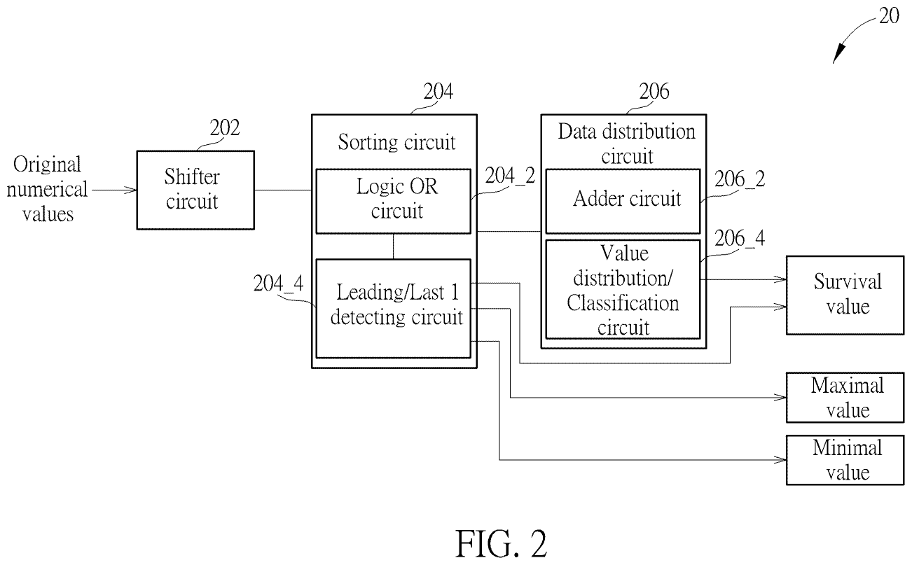

In detail, please refer to FIG. 2, which is a schematic diagram of a numerical data processing device 20 according to an embodiment of the present invention. The numerical data processing device 20 includes a shifter circuit 202, a sorting circuit 204 and a data distribution circuit 206, wherein the sorting circuit 204 includes a logic OR circuit 204_2 and a leading/last 1 detecting circuit 204_4, the data distribution circuit 206 includes an adder circuit 206_2 and a value distribution/classification circuit 206_4. In an embodiment, the shifter circuit 202 includes multiple shifters, the logic OR circuit 204_2 includes multiple logic ORs OR, the adder circuit 206_2 includes multiple adders ADDER.

The numerical data processing device 20 according to an embodiment of the present invention transforms the original numerical values into the number sequences by the shifter circuit 202 to process formats of the numerical data in step 106 for implementation.

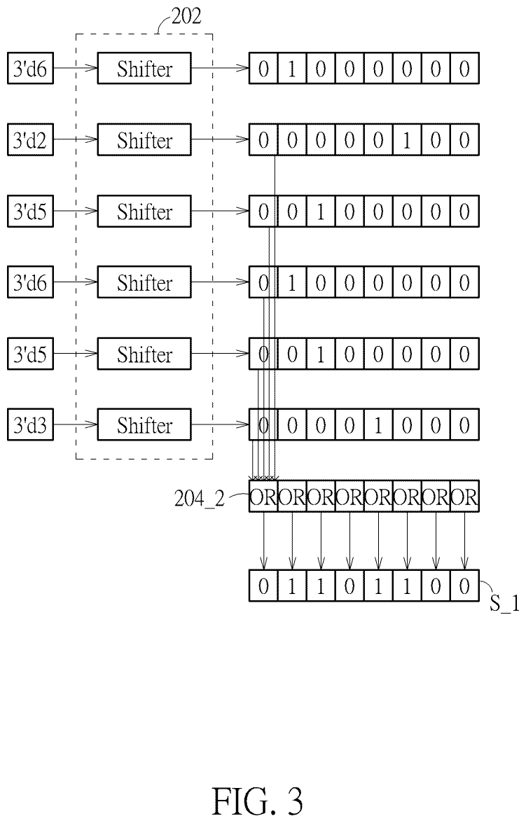

Regarding the method of parallel spreading the original numerical values into the number sequences by the numerical data processing device 20, please refer to FIG. 3, which is a schematic diagram of the sorting circuit 204 according to an embodiment of the present invention. In this example, the original numerical 3-bit values: 3′d6, 3′d2, 3′d5, 3′d6, 3′d5, 3′d3 are input to the shifter circuit 202 for spreading the original numerical 3-bit values into one-hot encoding of 8-bit (i.e., the number sequences).

Then, the logic OR circuit 204_2 of the sorting circuit 204 performs a logic OR processing for an identical bit of each sequence of the plurality of number sequences to obtain a first sequence S_1. The leading/last 1 detecting circuit 204_4 may detect the first sequence S_1, take a corresponding value of a leading value 1 of the first sequence S_1 as a maximal value of the original numerical values, and takes a corresponding value of a last value 1 of the first sequence S_1 as a minimal value of the original numerical values.

That is, a maximal value of the original data may be found by determining the first bit 1 (i.e., the leading 1) of the first sequence S_1. Similarly, other values may be determined accordingly, e.g., a second largest number of the first sequence S_1 is 3′d5 and a minimal value of the first sequence S_1 is 3′d2.

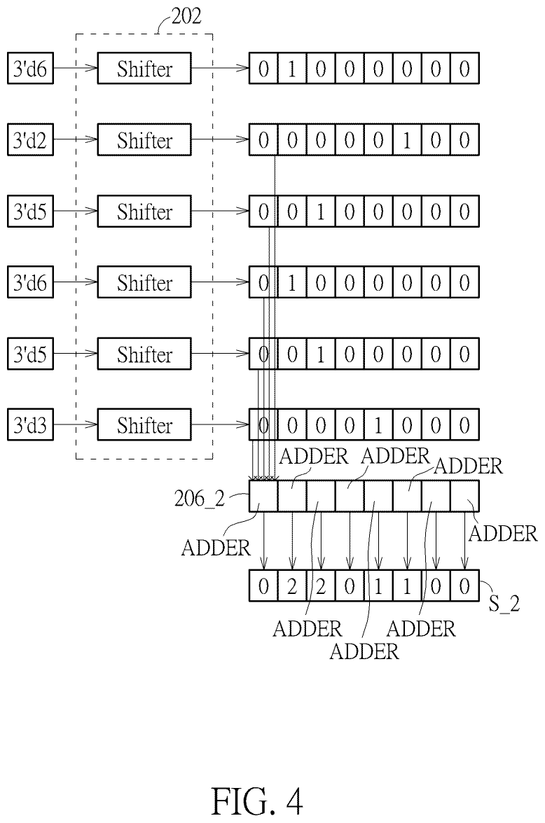

Please refer to FIG. 4, which is a schematic diagram of the data distribution circuit 206 according to an embodiment of the present invention. In this example, the adder circuit 206_2 of the data distribution circuit 206 performs a logic AND processing for an identical bit of each sequence of the number sequences to obtain a second sequence S_2. In such situation, a 1-bit counter (composed of a single T-type flip-flop) may be utilized for determining a total number of each values according to a sum of corresponding bit of the second sequence S_2, i.e., numbers of 3′d7, 3′d6, 3′d5, 3′d4, 3′d3, 3′d2, 3′d1, 3′d0 are respectively 0, 2, 2, 0, 1, 1, 0, 0.

Therefore, the value distribution/classification circuit 206_4 of the data distribution circuit 206 may determine a data value distribution of the original numerical values according to the second sequence S_2.

The data distribution circuit 206 of the numerical data processing method 10 according to an embodiment of the present invention illustrated in FIG. 4 may determine the number of different values to obtain statistics information of the original numerical values, the sorting circuit 204 in FIG. 3 may determine required number or value the original numerical values, i.e., the survival values, to execute a survival path searching function for a deep learning network.

In addition, as shown in FIG. 3 and FIG. 4, the sorting circuit 204 and the data distribution circuit 206 of the numerical data processing device 20 according to an embodiment of the present invention are parallel processing, which reduces cascade circuits and achieves shorter critical path in the circuit design.

Notably, the numerical data processing device 20 of the above embodiment may be implemented by Field Programmable Gate Array (FPGA), the shifter circuit, the adder circuit, the logic OR and the leading/last 1 detecting circuit may be modified according to different requirements, which are all within the scope of the present invention.

In summary, the present invention discloses a processing method and a related processing device for numerical data to achieve shorter critical paths in circuitry processing to perform data sorting and data distribution.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A numerical data processing method, comprising:
transforming a plurality of original numerical values of data into a plurality of number sequences; and
determining a maximal value, a minimal value and at least a survival value of the plurality of number sequences according to a sorting result of the plurality of number sequences;
wherein the plurality of number sequences are one-hot encoding.

2. The numerical data processing method of claim 1, wherein the step of determining the maximal value, the minimal value and the at least a survival value of the plurality of number sequences according to the sorting result of the plurality of number sequences comprises:
performing a logic OR processing for an identical bit of each sequence of the plurality of number sequences to obtain a first sequence; and
taking a corresponding value of a leading value 1 of the first sequence as a maximal value of the plurality of original numerical values, and taking a corresponding value of a last value 1 of the first sequence as a minimal value of the plurality of original numerical values.

3. The numerical data processing method of claim 1, wherein the step of determining the maximal value, the minimal value and the at least a survival value of the plurality of number sequences according to the sorting result of the plurality of number sequences comprises:
performing a logic AND processing for an identical bit of each sequence of the plurality of number sequences to obtain a second sequence; and
determining a data value distribution of the plurality of original numerical values according to the second sequence.

4. The numerical data processing method of claim 1, wherein transforming the plurality of original numerical values into the plurality of number sequences is implemented by a Field Programmable Gate Array (FPGA).

5. The numerical data processing method of claim 1, further comprising:
executing a survival path searching function according to the at least a survival value of the plurality of number sequences for a deep learning network.

6. A numerical data processing device, comprising:
a shifter circuit, for receiving a plurality of original numerical values of data and transforming the plurality of original numerical values of the data into a plurality of number sequences;
a sorting circuit, for sorting the plurality of number sequences and determining a maximal value, a minimal value of the plurality of number sequences according to a sorting result of the plurality of number sequences; and
a data distribution circuit, for determining at least a survival value according to the plurality of number sequences;
wherein the plurality of number sequences are one-hot encoding.

7. The numerical data processing device of claim 6, wherein the sorting circuit includes a logic OR circuit and a leading/last 1 detecting circuit, for performing a logic OR processing for an identical bit of each sequence of the plurality of number sequences to obtain a first sequence; and for taking, by the leading/last 1 detecting circuit, a corresponding value of a leading value 1 of the first sequence as a maximal value of the plurality of original numerical values, and taking a corresponding value of a last value 1 of the first sequence as a minimal value of the plurality of original numerical values.

8. The numerical data processing device of claim 6, wherein the data distribution circuit includes an adder circuit and a value distribution/classification circuit, for performing a logic AND processing for an identical bit of each sequence of the plurality of number sequences to obtain a second sequence; and determining, by the value distribution/classification circuit, a data value distribution of the plurality of original numerical values according to the second sequence.

9. The numerical data processing device of claim 6, wherein transforming the plurality of original numerical values into the plurality of number sequences is implemented by a Field Programmable Gate Array (FPGA).

10. The numerical data processing device of claim 6, wherein the data distribution circuit further includes value distribution/classification circuit for executing a survival path searching function according to the at least a survival value of the plurality of number sequences for a deep learning network.
